(19) United States
(12) Patent Application Publication
(10) Pub. No.: US 2015/0009895 A1
(43) Pub. Date: Jan. 8, 2015

(54) METHOD AND APPARATUS FOR REPORTING AND CANCELLING CROSS-SUBFRAME CO-CHANNEL INTERFERENCE

(71) Applicants: Dalin Zhu, Beijing (CN); Zhennian Sun, Beijing (CN); Yu Zhang, Beijing (CN); Gang Wang, Beijing (CN); Ming Lei, Beijing (CN)

(72) Inventors: Dalin Zhu, Beijing (CN); Zhennian Sun, Beijing (CN); Yu Zhang, Beijing (CN); Gang Wang, Beijing (CN); Ming Lei, Beijing (CN)

(73) Assignee: NEC (CHINA) CO., LTD., Beijing (CN)

(21) Appl. No.: 14/345,079

(22) PCT Filed: Mar. 27, 2012
(86) PCT No.: PCT/CN2012/073152

§ 371 Date: Sep. 8, 2014

(51) Int. Cl. H04B 1/10; H04W 24/08

(52) U.S. Cl. CPC H04B 1/1027; H04W 24/08; H04B 2001/1045
USPC 370/328

(57) ABSTRACT

Embodiments of the disclosure provide methods and apparatuses for cancelling cross-subframe co-channel interference (CCI). The method comprising receiving a channel quality indicators (CQI) of a cross-subframe from user equipment (UE), wherein the cross-subframe is a downlink subframe that is interfered by an uplink subframe in a neighboring cell; determining if the UE should be scheduled during cross-subframes based on at least the CQI; scheduling the UE during the cross-subframes if the UE is determined to be scheduled. By means of measuring and reporting CQIs on cross-subframe at UEs, base stations may determine more accurately if interferences at the cross-subframes are severe enough and if resources should be scheduled at the cross-subframe.

### FIELD OF THE INVENTION

Embodiments of the present invention generally relate to communication techniques. More particularly, embodiments of the present invention relate to a method and apparatus for reporting and cancelling cross-subframe co-channel interference (CCI).

### BACKGROUND OF THE INVENTION

3GPP LTE and LTE-Advanced, also known as the evolution standard of the great success of GSM/HSPA technology, is aiming at creating a new series of specifications for the new evolving radio-access technology. One of its goals is to go on improving the communication system performance, such as the higher throughput. LTE has two different duplex modes for separating the transmission directions from the user to the base station and back: frequency division duplex (FDD) and time division duplex (TDD). In the TDD duplex mode, a single bandwidth is shared between uplink (UL) and downlink (DL), with the sharing being performed by allotting different periods of time to uplink and downlink. In LTE TDD system, there are 7 different patterns of uplink/downlink switching, termed uplink-downlink configurations 0 through 6. LTE TDD system allows for asymmetric UL-DL allocations by the seven different uplink-downlink configurations. Generally, LTE TDD system statically or semi-statically allocates the uplink-downlink configuration among cells. As shown in FIG. 1, all the neighboring cells have the same uplink-downlink configuration 0 after configurations of the cells are deployed by the LTE TDD system. The configuration allocation is not changed during operation (static allocation) or is changed after years of operation (semi-static allocation).

In some scenarios, the static or semi-static allocation may not match the instantaneous traffic condition. Hence, there is a need to employ additional mechanisms in LTE TDD system, e.g., dynamic allocation of subframes to UL or DL. The dynamic deployment of UP-DL configuration among cells is possibly changed every 10 ms or 640 ms. As shown in FIG. 2, at one instant, Cell 0 may be deployed to have the UP-DL configuration 4, while the neighboring cells may be deployed to have the UP-DL configuration 0. However, deploying different UP-DL configurations among neighboring cells in TDD system would result in cross-subframe co-channel interference. A cross-subframe is a down link subframe that is interfered by an upper link subframe of a neighboring cell. The cross-subframe co-channel interference (CCI) is that the DL subframes in a cell of interest are interfered on the same channel by a UL subframe in a neighboring cell, i.e. the so-called UE-UE cross-subframe co-channel interference. As shown in FIG. 3, UE 0 in Cell 0 is deployed to use UP-DL configuration 5 while UE 1, which is near UE 0 and is located in the neighboring Cell 1, is deployed to use UP-DL configuration 6. In this case, UE 0 is interfered by UE 1 on subframe 4 because subframe 4 in configuration 5 at UE 0 is configured to transmit downlink data while subframe 4 of configuration 6 at UE 1 is configured to transmit uplink data on the same channel.

Employing effective CCI cancellation (CCIC) methods is important if dynamic reconfiguration is allowed in LTE TDD system. One of CCIC methods is scheduling a UE according to the distance between the UE and the base station. As shown in FIG. 4, the base station will not schedule UEs whose distances to the base station are larger than a predefined distance because these UEs are near the neighboring cells and possibly suffer CCI by other nearby UEs which have different UP-DL configurations.

However, in practice, it may be difficult to measure the physical distance between the UE and the base station. In addition, the physical distance may not adequately reveal the interference experienced by the UE. For example, a UE that is far away from the base station may not suffer CCI when no other UE is nearby or the CCI is not severe even other UEs with different UP-DL configurations are nearby.

### SUMMARY OF THE INVENTION

In view of the foregoing problems, there is a need to improve the distance-based UE-UE CCIC. The present invention proposes a CCIC solution which considers actual interferences reported by UEs to determine the scheduling of resources.

According to a first aspect of the present invention, embodiments of the invention provide a method for cancelling cross-subframe co-channel interference (CCI), comprising receiving a channel quality indicators (CQI) of a cross-subframe from user equipment (UE), wherein the cross-subframe is a downlink subframe that is interfered by an uplink subframe in a neighboring cell; determining if the UE should be scheduled during cross-subframes based on at least the CQI; scheduling the UE during the cross-subframes if the UE is determined to be scheduled.

According to a second aspect of the present invention, embodiments of the invention provide a method for reporting cross-subframe co-channel interference (CCI), comprising measuring a channel quality indicator (CQI) of a cross-subframe at a user equipment (UE), wherein the cross-subframe is a downlink subframe that is interfered by an uplink subframe in a neighboring cell; reporting the CQI to a base station.

According to a third aspect of the present invention, embodiments of the invention provide an apparatus for cancelling cross-subframe co-channel interference (CCI), comprising a receiving unit configured to receive a channel quality indicators (CQI) of a cross-subframe from user equipment (UE), wherein the cross-subframe is a downlink subframe that is interfered by an uplink subframe in a neighboring cell; a determining unit configured to determine if the UE should be scheduled during cross-subframes based on at least the CQI; a scheduling unit configured to schedule the UE during the cross-subframes if the UE is determined to be scheduled.

According to a third aspect of the present invention, embodiments of the invention provide an apparatus for reporting cross-subframe co-channel interference (CCI), comprising a measuring unit configured to measure a channel quality indicator (CQI) of a cross-subframe at a user equipment (UE), wherein the cross-subframe is a downlink subframe that is interfered by an uplink subframe in a neighboring cell; a reporting unit configured to report the CQI to a base station.

The following benefits are expected with the invention. By means of measuring and reporting CQIs on cross-subframe at UEs, base stations may determine more accurately if interferences at the cross-subframes are severe enough and if resources should be scheduled at the cross-subframe based on the reported CQIs. By scheduling resources to non-CCI UEs, CCI may be cancelled and the overall resource usage will be increased according to the present invention.

Other features and advantages of the embodiments of the present invention will also be apparent from the following description of specific embodiments when read in conjunction with the accompanying drawings, which illustrate, by way of example, the principles of embodiments of the invention.

### BRIEF DESCRIPTION OF THE DRAWINGS

Embodiments of the invention are presented in the sense of examples and their advantages are explained in greater detail below, with reference to the accompanying drawings, where

FIG. 1 illustrates a schematic diagram of static or semi-static UP-DL configurations of cells in LTE TDD system;

FIG. 2 illustrates a schematic diagram of dynamic UP-DL configurations of cells in LTE TDD system;

FIG. 3 illustrates a schematic diagram of CCI due to different UP-DL configurations of two adjacent UEs;

FIG. 4 illustrates a schematic diagram of physical distance-based scheduling CCIC;

FIG. 5 illustrates a flow chart of a method for cancelling cross-subframe co-channel interference according to an embodiment of the invention;

FIG. 6 illustrates a flow chart of a method for reporting cross-subframe co-channel interference according to an embodiment of the invention;

FIG. 7 illustrates a block diagram of an apparatus for cancelling cross-subframe co-channel interference according to an embodiment of the invention; and

FIG. 8 illustrates a block diagram of an apparatus for reporting cross-subframe co-channel interference according to an embodiment of the invention.

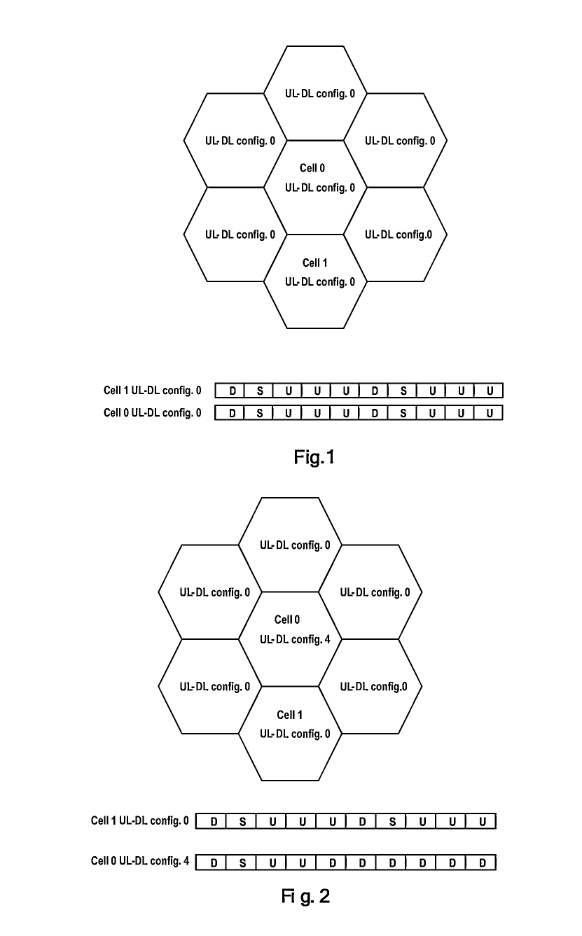

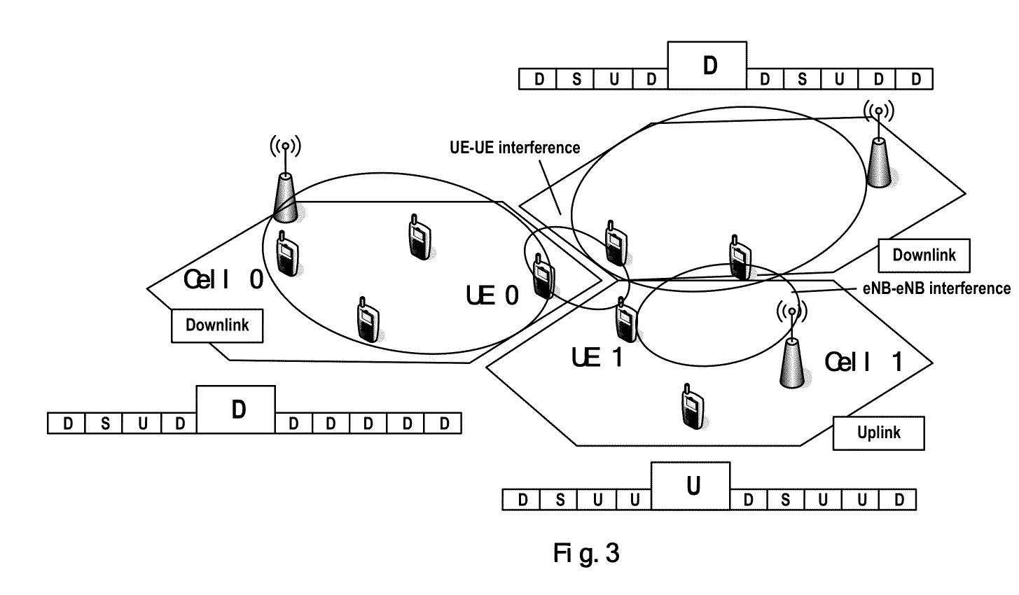

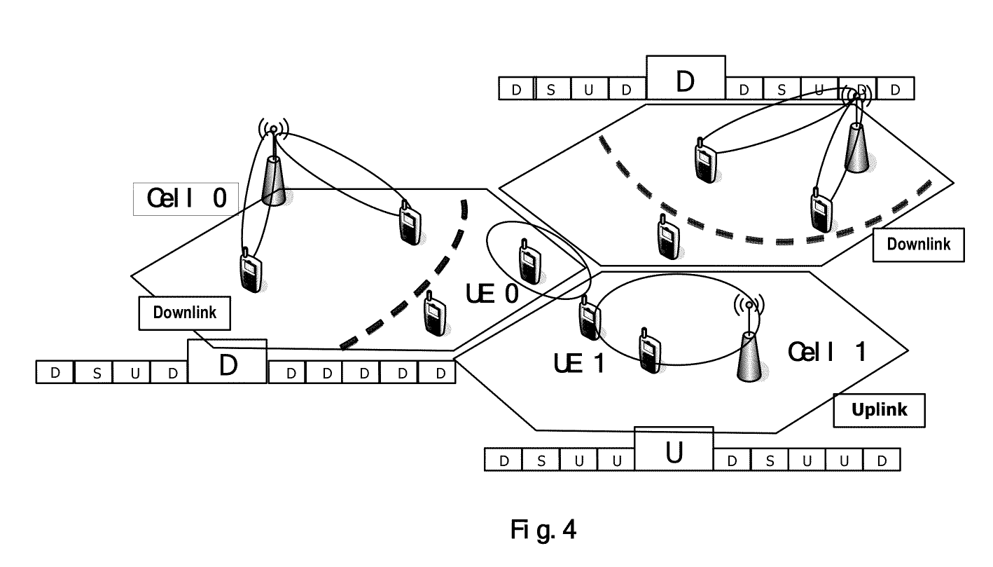

### DETAILED DESCRIPTION OF EMBODIMENTS

Various embodiments of the present invention are described in detail with reference to the drawings. The flowcharts and block diagrams in the figures illustrate the apparatus, method, as well as architecture, functions and operations executable by a computer program product according to the embodiments of the present invention. In this regard, each block in the flowcharts or block may represent a module, a program, or a part of code, which contains one or more executable instructions for performing specified logic functions. It should be noted that in some alternatives, functions indicated in blocks may occur in an order differing from the order as illustrated in the figures. For example, two blocks illustrated consecutively may be actually performed in parallel substantially or in an inverse order, which depends on related functions. It should also be noted that block diagrams and/or each block in the flowcharts and a combination of thereof may be implemented by a dedicated hardware-based system for performing specified functions/operations or by a combination of dedicated hardware and computer instructions.

In the disclosure, a user equipment (UE) may refer to a terminal, a Mobile Terminal (MT), a Subscriber Station (SS), a Portable Subscriber Station (PSS), Mobile Station (MS), or an Access Terminal (AT), and some or all of the functions of the UE, the terminal, the MT, the SS, the PSS, the MS, or the AT may be included.

In the disclosure, a base station (BS) may refer to a node B (NodeB or NB) or an evolved NodeB (eNodeB or eNB). A base station may be a macrocell BS or a small cell BS. According to the present invention, a macrocell BS may be a base station which manages a macrocell, for example, a macro eNB, and a small cell BS may be a base station which manages a small cell, for example, a pico eNB, a femto eNB, and some other suitable low power nodes.

FIG. 5 illustrates a flow chart of a method for cancelling cross-subframe co-channel interference according to an embodiment of the invention. The method of FIG. 5 may be performed at a base station which different UP-DL configurations may be dynamically deployed according to demand of data transmission.

The base station, as would be readily understood by those skilled in the art, can get UP-DL configurations of neighboring cells through connections therebetween. For example, the neighboring base stations may be connected by optical fibers or be controlled by a base station controller. Therefore, the dynamic UP-DL configurations of cells may be advertised to neighboring cells through the connections therebetween or by the base station controller. When the base station receives the UP-DL configurations of neighboring cells, the base station may compare the UP-DL configurations of neighboring cells with its own UP-DL configuration. If the UP-DL configurations of neighboring cells are different from the UP-DL configuration of its own on a subframe, the base station determines which subframes are cross-subframes and CCIs may be occurred on the cross-subframes. When the base station detects that a CCI may be occurred due to the different configurations of neighboring cells, a method for cancelling CCI may be started.

At step S510, the base station instructs a UE within the cell of the base station to report a channel quality indicator (CQI) of a cross-subframe. In one embodiment, the base station instructs the UE to report CQI of the cross-subframe when the cross-subframe is detected. In another embodiment, this step is optional because the UE may periodically report a CQI of a subframe that might be a cross-subframe in different UP-DL configurations to the base station without the instruction from the base station. For example, subframes 0 and 5 are used for download only in all UP-DL configurations and can not be cross-subframe. The UE may report CQI on other subframes other than subframes 0 and 5 to the base station and let the base station determine if the subframe on which a CQI is reported is a cross-subframe after receiving the reported CQI based on the current deployment of UP-DL configurations of neighboring base stations.

At step S520, the base station receives the CQI of the cross-subframe from the UE. As mentioned above, in one embodiment, the base station sends the instruction for reporting the CQI of the cross-subframe to the UE when the cross-subframe is detected. The base station may then wait for the CQI fed back from the UE. It is known that a UE may report CQIs to a base station through PUCCH (periodic report) or PUSCH (aperiodic report). Therefore, the reported CQI may be received periodically or aperiodically by the base station. Also as mentioned above, the UE may periodically report CQI on a subframe that potentially is a cross-subframe according to different UL-DL configurations. The base station decides the CQI is of a cross-subframe based on the current deployment of UP-DL configurations of neighboring base stations.

At step S530, the base station determines if the UE should be scheduled during cross-subframes based on at least the CQI. In one embodiment, the CQI of the cross-frame is compared with a threshold. If the CQI is lower than the threshold, it means that the UE is interfered by another UE on the cross-subframe. In the prior art, CCI is determined by the physical distance between the UE and the base station. However, as mentioned before, the distance may not be a decisive factor for determining CCI. In the present invention, the actual interferences on the cross-subframe are measured and reported by the UE. The actual interferences represented by CQI are more accurate than the physical distance between the UE and the base station as a factor for determining CCI.

Although CQI is used for determining the resource scheduling in embodiments of the invention, it is understood that other indicators that indicate the interference of the UE can also be used. For example, signal to interference noise ratio (SINR), which can be conducted from the reported CQI, may also be used to determine the resource scheduling in embodiments of the invention.

In one embodiment, the threshold may be predetermined on the basis of experience, simulation models or interference models.

At step S540, the base station schedules the UE during the cross-subframes if the UE is determined to be scheduled. Here, if the UE is determined not suffering CCI, the base station may schedule the UE. On the other hand, if the UE is suffering CCI according the reported CQI, then the UE is not scheduled so that resources may be scheduled to other UEs which are not suffered CCI. By scheduling resources to non-CCI UEs, CCI may be cancelled and the overall resource usage will be increased according to the present invention.

In one embodiment, the CQI of a cross-subframe is received later than the cross-subframe due to the delays of the network communication or the CQI report mechanism. In this scenario, the measured CQI at a cross-subframe may be used at a delayed cross-subframe to determine if the delayed cross-subframe should be scheduled. In a further embodiment, if multiple CQIs of cross-subframes are received periodically or aperiodically, the most recent CQI may be used in a delayed cross-subframe to determine if the delayed cross-subframe should be scheduled.

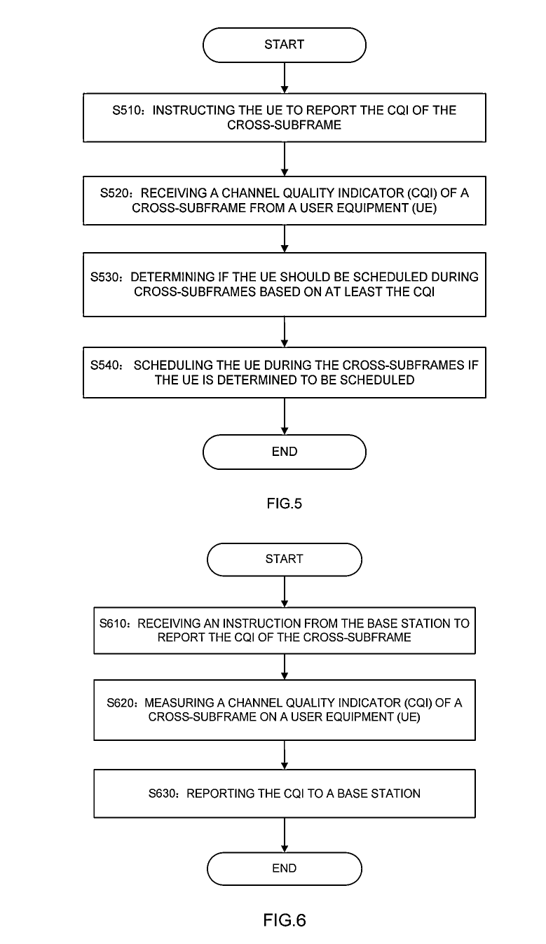

FIG. 6 illustrates a flow chart of a method for reporting cross-subframe co-channel interference according to an embodiment of the invention. The method of FIG. 6 may be performed at a UE which may be interfered by a nearby UE which has a different UP-DL configuration in a neighboring cell.

At step S610, a UE receives an instruction from a base station to report a CQI of a cross-subframe. In one embodiment, as mentioned before, when the base station detects that CCI may occur due to the different UP-DL configurations among neighboring cells, the base station may informs which subframe is a cross-subframe and instructs the UE to report its CQI on the cross-subframe. In another embodiment, also as mentioned before, the step is optional because a UE may periodically report a CQI of a potential cross-subframe without the instruction from the base station.

At step S620, the UE measures the channel quality indicator of the cross-subframe. As mentioned above, the cross-subframe is the cross-subframe indicated in the instruction sent by the base station or potential cross-subframe according to the different UP-DL configurations.

At step S630, the UE reports the measured CQI of the cross-subframe to the base station so that the base station may determine if the UE should be scheduled on the cross-subframe in accordance with the reported CQI.

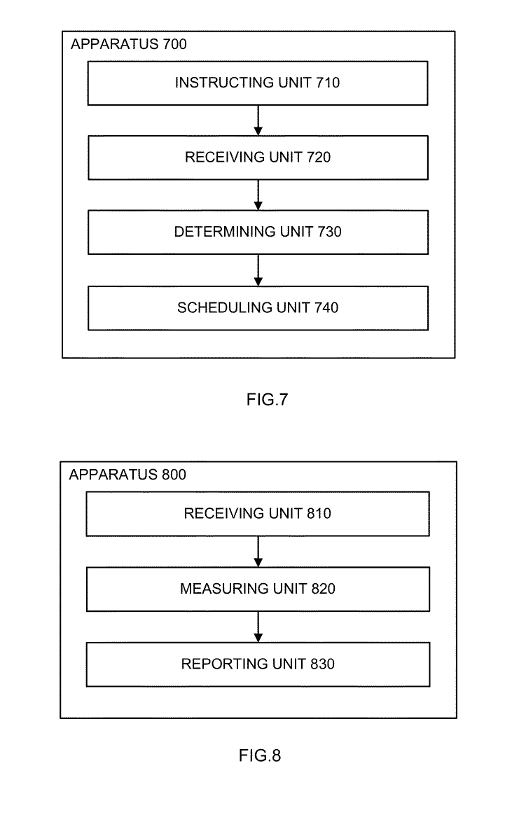

FIG. 7 illustrates a block diagram of an apparatus 700 for cancelling cross-subframe co-channel interference according to an embodiment of the invention. The apparatus may be used in a base station.

In this embodiment, the apparatus 700 comprises a receiving unit 720, a determining unit 730 and a scheduling unit 740. The receiving unit 720 may be configured to receive a channel quality indicator (CQI) of a cross-subframe from a user equipment (UE), the cross-subframe is a down link subframe that is interfered by an upper link subframe of a neighboring cell. The determining unit 730 may be configured to determine if the UE should be scheduled during cross-subframes based on at least the CQI. The scheduling unit 740 may be configured to schedule the UE during the cross-subframes if the UE is determined to be scheduled.

In another embodiment, the apparatus 700 may optionally comprise an instruction unit 710. The instructing unit 710 may be configured to instruct the UE to report the CQI of the cross-subframe.

In further embodiment of the present invention, the determining unit 730 may be further configured to determine the UE should be scheduled during cross-subframes if the CQI is higher than a threshold.

In further embodiment of the present invention, the scheduling unit 740 may be further configured to schedule the UE during a delayed cross-subframe of the UE based on a previously reported CQI.

FIG. 8 illustrates a block diagram of an apparatus 800 for reporting cross-subframe co-channel interference according to an embodiment of the invention. The apparatus may be used in a UE.

In this embodiment, the apparatus 800 comprises a measuring unit 820 and a reporting unit 830. The measuring unit 820 may be configured to measure a channel quality indicator of a cross-subframe at the user equipment. The reporting unit 830 may be configured to report the CQI to a base station.

In further embodiment of the present invention, the apparatus 800 may optionally comprise a receiving unit 810 configured to receive an instruction from the base station to report the CQI of the cross-subframe. The instructions may indicate which subframe is a cross-subframe and on which a CQI should be measured and reported.

Based on the above description, the skilled in the art would appreciate that the present disclosure may be embodied in an apparatus, a method, or a computer program product. In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flowcharts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The various blocks shown in FIGS. 5 and 6 may be viewed as method steps, and/or as operations that result from operation of computer program code, and/or as a plurality of coupled logic circuit elements constructed to carry out the associated function(s). At least some aspects of the exemplary embodiments of the disclosures may be practiced in various components such as integrated circuit chips and modules, and that the exemplary embodiments of this disclosure may be realized in an apparatus that is embodied as an integrated circuit, FPGA or ASIC that is configurable to operate in accordance with the exemplary embodiments of the present disclosure.

While this specification contains many specific implementation details, these should not be construed as limitations on the scope of any disclosure or of what may be claimed, but rather as descriptions of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications, adaptations to the foregoing exemplary embodiments of this disclosure may become apparent to those skilled in the relevant arts in view of the foregoing description, when read in conjunction with the accompanying drawings. Any and all modifications will still fall within the scope of the non-limiting and exemplary embodiments of this disclosure. Furthermore, other embodiments of the disclosures set forth herein will come to mind to one skilled in the art to which these embodiments of the disclosure pertain having the benefit of the teachings presented in the foregoing descriptions and the associated drawings.

Therefore, it is to be understood that the embodiments of the disclosure are not to be limited to the specific embodiments disclosed and that modifications and other embodiments are intended to be included within the scope of the appended claims. Although specific terms are used herein, they are used in a generic and descriptive sense only and not for purposes of limitation.

1. A method for cancelling cross-subframe co-channel interference (CCI), comprising:
receiving a channel quality indicators (CQI) of a cross-subframe from user equipment (UE), wherein the cross-subframe is a downlink subframe that is interfered by an uplink subframe in a neighboring cell;
determining if the UE should be scheduled during cross-subframes based on at least the CQI;
scheduling the UE during the cross-subframes if the UE is determined to be scheduled.

2. The method of claim 1, wherein the CQI is received periodically.

3. The method of claim 1, further comprising:
instructing the UE to report the CQI of the cross-subframe.

4. The method of claim 1, wherein the determining step further comprises:
determining the UE should be scheduled during cross-subframes if the CQI is higher than a threshold.

5. The method of claim 1, wherein scheduling step further comprises scheduling the UE during a delayed cross-subframe of the UE based on a previously reported CQI.

6. A method for reporting cross-subframe co-channel interference (CCI), comprising:
measuring a channel quality indicator (CQI) of a cross-subframe at a user equipment (UE), wherein the cross-subframe is a downlink subframe that is interfered by an uplink subframe in a neighboring cell;
reporting the CQI to a base station.

7. The method of claim 6, wherein the CQI is measured periodically.

8. The method of claim 6, further comprising:
receiving an instruction from the base station to report the CQI of the cross-subframe.

9. An apparatus for cancelling cross-subframe co-channel interference (CCI), comprising:
a receiving unit configured to receive a channel quality indicators (CQI) of a cross-subframe from user equipment (UE), wherein the cross-subframe is a downlink subframe that is interfered by an uplink subframe in a neighboring cell;
a determining unit configured to determine if the UE should be scheduled during cross-subframes based on at least the CQI;
a scheduling unit configured to schedule the UE during the cross-subframes if the UE is determined to be scheduled.

10. The apparatus of claim 9, wherein the CQIs is received periodically.

11. The apparatus of claim 9, further comprising:
an instructing unit configured to instruct the UE to report the CQI of the cross-subframe.

12. The apparatus of claim 9, wherein the determining unit further configure to determine the UE should be scheduled during cross-subframes if the CQI is higher than a threshold.

13. The apparatus of claim 9, wherein the scheduling unit further configured to schedule the UE during a delayed cross-subframe of the UE based on a previously reported CQI.

14. An apparatus for reporting cross-subframe co-channel interference (CCI), comprising:
a measuring unit configured to measure a channel quality indicator (CQI) of a cross-subframe at a user equipment (UE), wherein the cross-subframe is a downlink subframe that is interfered by an uplink subframe in a neighboring cell;
a reporting unit configured to report the CQI to a base station.

15. The apparatus of claim 14, wherein the CQI is measured periodically.

16. The apparatus of claim 14, further comprising:
a receiving unit configured to receive an instruction from the base station to report the CQI of the cross-subframe.
